(19) United States
(12) Patent Application Publication
(10) Pub. No.: US 2012/0184464 A1
(43) Pub. Date: Jul. 19, 2012

(54) SYSTEM AND METHOD FOR HIGH DENSITY ASSEMBLY AND PACKING OF MICRO-REACTORS

(75) Inventors: Abraham P. Lee, Irvine, CA (US); Andrew C. Hatch, American Fork, UT (US); Jeffrey S. Fisher, San Diego, CA (US)

(73) Assignee: THE REGENTS OF THE UNIVERSITY OF CALIFORNIA, Oakland, CA (US)

(21) Appl. No.: 13/249,096

(22) Filed: Sep. 29, 2011

Related U.S. Application Data
(60) Provisional application No. 61/388,538, filed on Sep. 30, 2010.

(51) Int. Cl. C40B 40/08; C40B 50/18

(52) U.S. Cl. 506/17; 506/32

(57) ABSTRACT

A method and device is disclosed for increasing droplet and micro-well reactor densities per unit area for microfluidic platforms. The device and method use controlled Height to Droplet Diameter Ratios (HDR) of the collection region which can produce different crystalline packing formations. HDR ratios above unity and less than about 2.65 are used to create a variety of three-dimensional packing schemes with increased density over conventional single layer hexagonal packing.

### RELATED APPLICATION

This application claims priority to U.S. Provisional Patent Application No. 61/388,538 filed on Sep. 30, 2010. Priority is claimed pursuant to 35 U.S.C. §119. The above-noted Patent Application is incorporated by reference as if set forth fully herein.

### STATEMENT REGARDING FEDERALLY SPONSORED RESEARCH OR DEVELOPMENT

This invention was made with government support under HR0011-06-1-0050 awarded by DARPA and N66001-10-4003 awarded by the Navy, Space & Naval Warfare Systems Command. The government has certain rights in the invention.

### FIELD OF THE INVENTION

The field of the invention generally relates to micro-well and droplet-reactor arrays. In particular, the field of the invention relates to a method and system for increasing micro-reactor densities by using three-dimensional arrangements of self-assembled, crystalline-formation droplet patterns or complimentary aligned multilayer micro-well arrays.

### BACKGROUND OF THE INVENTION

Often in microfluidic applications, there is a need to image two-dimensional imaging planes of micro-wells or reactor droplet arrays. Such micro-wells and droplet arrays typically contain target subjects, such as rare cells, genetic components, or other material, that are analyzed using bright field or fluorescence imaging. High density micro-well plates or micro-reactors have been fabricated using various methods to form an array of wells into a configuration having a surface that is suitable for imaging, so the target subjects therein can be viewed, monitored, and/or collected. By increasing the density of the arrays, imaging of the arrays may be improved, and more material may be contained in the arrays for analysis. This in turn results in an increase in analysis throughput and dynamic range for real-time monitoring of subject samples. This is particularly useful in high throughput applications such as early pathogen detection or quality control screening where biomarkers exist in very low concentrations, thus requiring analysis of larger volumes and/or more reactor samples.

The densities of such high-density arrays, however, are often restricted by pattern formation of the micro-wells and manufacturing techniques, thus limiting the arrays to single layer and two-dimensional (2D) patterns having reduced height-to-width aspect ratios. As a result, a large useable area between the micro-wells may be lost, depending on the pitch or spacing between the micro-wells. For example, in some high-density arrays, dead space occupies 10-50% of the imaging area, and consequently less occupied space results in lower analysis throughput. In other words, it is necessary to minimize spacing between the micro-wells in order to increase their density for greater throughput analysis,

As an alternative to solid phase micro-wells on a planar array, droplet reactors can be utilized, wherein the droplet reactors are able to self-assemble into a number of hexagonal-shaped droplet formations with only thin film separations between them. However, the density of the droplet formations is still restricted by the typical spherical shape of the droplets, particularly when the droplets are limited to 2D formations. This limits the formations to low density circle packing configurations and 1:1 height-to-width aspect ratios, and also leads to a significant trade-off in volume with reductions in size to increase density. Moreover, the limits in manufacturability of high height-to-width aspect ratios are prohibitive in increasing reactor densities beyond a certain value, as an increase in reactor density may adversely affect the possible volume each reactor can contain. Finally, reducing reactor areas to increase density may result in an imaging area that is too small to maintain adequate imaging resolution and reactor volume. In the case of micro-wells, it is also difficult to fill each reactor in view of the dominant influence of surface tension at decreasing length scales.

Because of the above deficiencies, micro-well and droplet-reactor arrays have been exclusively limited to single layer and 2D configurations with zero overlap of reactor areas on the imaging plane. These standard configurations of reactors greatly limit the total density of wells or droplets possible per unit area, thus limiting imaging views and consequently limiting analysis throughput. Therefore, there is a need for a device and method with increased droplet and micro-well reactor densities per unit area for high density platforms and applications.

### SUMMARY

A process and method of use is disclosed to increase micro-reactor densities per unit area using a three dimensional arrangement of self-assembled crystalline formation droplet patterns to increase reactor density, thereby utilizing 100% of the imaging plane and increasing reactor density as much as three-fold (3×), without having to modify reactor size, volume, or shape. This is achieved by allowing partial overlap of reactors in one imaging plane with reactors in another imaging plane, wherein the reactors in each imaging plane are separated by a small offset on the order of less than a single droplet diameter. This process is well suited for monitoring fluorescence intensity values within individual droplets, as well as other optical probing techniques where light can be transmitted from all reactor planes to the imaging plane. The small separation between droplet planes eliminates the need for confocal, or other complicated imaging techniques, because such arrangement does not require a prohibitively large depth of field imaging setup. Moreover, the increased density of the droplets and utilization of the imaging plane allow for higher throughput analysis of biological and/or chemical samples, as a greater number of micro-reactors can be captured and processed in a single picture frame.

Although reactor areas in underlying layers partially overlap with those layers above, the patterning formations generally do not allow for a 100% overlap of any single reactor with another. Therefore, image capture information from all reactors can be individually resolved in the image. For low overlapping percentages, partial regions of the underlying reactors are always visible, and the overlapping regions of various reactors can be interpolated from each other based on pattern recognition and image processing techniques well known in the art. The uppermost layers closest to the imaging plane are always 100% visible; however, information in those areas is still comprised from light transmission through the layers from underlying droplet reactors. This occurs because of the transparent nature of aqueous droplet contents and oil phases allowing for the transmission of light, resulting in little loss of information from droplet-reactors in as many as two or three droplet reactor planes. Furthermore, the refractive indices of the emulsified fluids and materials can be tuned to reduce lensing effects, including both refractions and reflections, to further reduce background noise levels and loss of light transmission to the imaging plane from underlying reactor planes.

Using the inherent properties of droplet emulsions, one can control the droplet pattern formations between a top and bottom chamber wall in which the droplets are placed to favor predictable self-assembled crystalline pattern formations of relatively monodisperse droplets with varying degrees of droplet plane separation and overlap tolerances. The self-assembled crystalline pattern occurs in three dimensions and can be stacked in the vertical direction between the top and bottom chamber surfaces. This self-assembly occurs when the discrete phase to continuous phase volume ratio is very high, forcing the droplets to pack as close together as possible. Furthermore, by controlling the separation height between the top and bottom chamber surfaces relative to the droplet diameter, predictable crystalline pattern formations will result. As long as the image-capturing sensor can visualize all layers of the formation, each reactor can be quantifiably analyzed just as one would perform a standard micro-well plate reading using a slide scanner array, microscope image, or other similar imaging medium. So long as all materials between the imaging sensor and farthest reactor plane are transparent, the contents of all droplet reactors can be quantifiably analyzed.

In one embodiment of the present invention, a method of collecting micro-reactors includes forming a plurality of micro-reactors in a microfluidic device, each of the micro-reactors having a diameter (D), and transporting the micro-reactors into a collection region having a lower surface and an upper surface, wherein the lower surface is separated from the upper surface by a height (H), and wherein the ratio of H:D is between 1.0 and 1.9. In some instances, such as three-layer designs, the ratio of H:D can increase to up to 2.65.

In another embodiment, a microfluidic device includes one or more microfluidic channels configured to hold a plurality of micro-reactors having a diameter (D), the one or more microfluidic channels terminating in a collection region having a lower surface and an upper surface, wherein the lower surface is separated from the upper surface by a height (H), and wherein the ratio of H:D is between 1.0 and 1.9. In some instances, such as three-layer designs, the ratio of H:D can increase to up to 2.65. The device may also include, in some embodiments, an imaging device configured to take a two-dimensional image of the micro-reactors in the collection region. In still other embodiments, the imaging device may be able to take a three-dimensional image of the collection region as opposed to a two-dimensional image.

In still another embodiment of the invention, a micro-reactor assembly in a microfluidic device includes a plurality of micro-reactors each having a diameter (D) and assembled in a chamber having a lower surface and an upper surface separated by a height (H), wherein the ratio of H:D is between 1.0 and 2.65, and wherein the plurality of micro-reactors form a self-assembled imaging configuration.

### BRIEF DESCRIPTION OF THE DRAWINGS

FIG. 1 illustrates a photograph of droplet generation of a monodisperse droplet array with a high water:oil (w/o) volume ratio on a microfluidic device using a 256 droplet splitter design. This enables generation of larger droplets at high water/oil volume ratios to be subsequently split into multiple smaller droplets of a smaller volume and diameter.

FIG. 2 illustrates a photograph of the generation of droplets rapidly self-assembling into predictable crystalline pattern formations upon entering a large droplet reactor chamber.

FIG. 3A illustrates an exemplary collection reservoir having a chamber height (H) with a droplet therein having diameter (D).

FIG. 3B illustrates an exemplary collection reservoir having a varying chamber heights (H) along a portion thereof.

FIG. 3C illustrates a system that includes an imaging device and computer along with an exemplary collection reservoir.

FIG. 4A illustrates the crystalline pattern formation predictions based on a spherical droplet model for different chamber height (H) to droplet diameter (D) ratios. Also illustrated is the HDR value required to accomplish each cubic lattice droplet pattern using a spherical droplet model.

FIG. 4B illustrates top and side views of a droplet packing configuration in Miller lattice orientations for a single layer (111). Also illustrated is the HDR value required to accomplish each cubic lattice droplet pattern using a spherical droplet model.

FIG. 4C illustrates top and side views of a droplet packing configuration in Miller lattice orientations for a double layer (110). Also illustrated is the HDR value required to accomplish each cubic lattice droplet pattern using a spherical droplet model.

FIG. 4D illustrates top and side views of a droplet packing configuration in Miller lattice orientations for a double layer (100). Also illustrated is the HDR value required to accomplish each cubic lattice droplet pattern using a spherical droplet model.

FIG. 4E illustrates top and side views of a droplet packing configuration in Miller lattice orientations for a double layer (111). Also illustrated is the HDR value required to accomplish each cubic lattice droplet pattern using a spherical droplet model.

FIG. 4F illustrates top and side views of a droplet packing configuration in miller lattice orientations for a triple layer (111) like Hexagonal Close Packing (HCP) and Cubic Close Packing (CCP) configurations. Also illustrated is the HDR value required to accomplish each cubic lattice droplet pattern using a spherical droplet model.

FIGS. 5A-5D illustrate digital microfluidic images (fluorescent) with various HDR values (HDR as used herein refers to the mathematical ratio of H:D in a droplet). FIG. 5A illustrates an HDR=1, with single layer hexagonal packing, zero overlap of droplets. FIG. 5B illustrates an HDR=˜1.45, with a close packing arrangement, ˜17% increase in density. FIG. 5C illustrates an HDR=1.7, with close square packing of droplets resulting in ˜73% droplet overlap and ˜73% increase in packing density. FIG. 5D illustrates an HDR=1.82, with double layer hexagonal packing with ˜93% overlap of droplets and ˜100% increase in droplet density.

FIGS. 6A-6E illustrate the visualization of self-organizing droplet sphere packing configurations as a function of chamber height and droplet diameter. FIG. 6A illustrates single layer packing FIG. 6B illustrates double layer square packing FIG. 6C illustrates double layer hexagonal packing FIG. 6D illustrates triple layer hexagonal packing (configuration A). FIG. 6E illustrates triple layer hexagonal packing (configuration B).

FIGS. 7A-7H illustrates a comparison of bright field images (FIGS. 7A-7D) and fluorescence (FIGS. 7E-7H) images of single layer to triple layer self-assembled droplet sphere packing configurations viewed on an Olympus inverted microscope.

FIGS. 8A-8E illustrate a composition of fluorescence images demonstrating single layer to triple layer self-assembled droplet sphere packing configurations. Scale bars are 100 μm.

FIG. 9 illustrates the microfluidic design of 128 droplet splitter device and droplet-packing chamber. The 128-droplet splitter consists of a 240 mm parent channel that bifurcates 7 times at 45° angles to form 2⁷ daughter channels with 30 mm widths. After each bifurcation junction 1-6, the channel width is reduced at a rate of √2.

FIG. 10A illustrates the radial profile plots of droplets in each layer of the varying droplet pattern formations. Scale bar is 50 μm. Radial profile plot of fluorescent droplets measured from center of fluorescent droplet outwards comprising n=1 (111), n=2 (110), (100), (111) and n=3 (111) HCP lattice formations (N≧2). Notice the average decrease in relative intensity between n=1 and n=2 is less than 10-20%, whereas the third layer in n=3 is reduced by as much as 50%. (Inset is an illustration of droplet image with concentric rings defining 25% radial distance intervals from which averaged intensity profile measurements are taken).

FIG. 10B illustrates surface intensity plots of droplets in each layer of the varying droplet pattern formations demonstrating the level of fluctuation exhibited in each droplet's fluorescence intensity. Composition of enlarged single droplet images in each lattice structure position with relative intensity adjustment and contrast enhancement performed to emphasize intensity profiles over the imaging plane.

FIG. 10C illustrates the three-dimensional intensity surface plots of the same images of FIG. 10B for better profile visualization. Left to right, fluorescence intensity images are n=1 (111), second layer of n=2 (110), (100), and (111), and third layer of n=3 HCP droplet positions.

### DETAILED DESCRIPTION OF THE ILLUSTRATED EMBODIMENTS

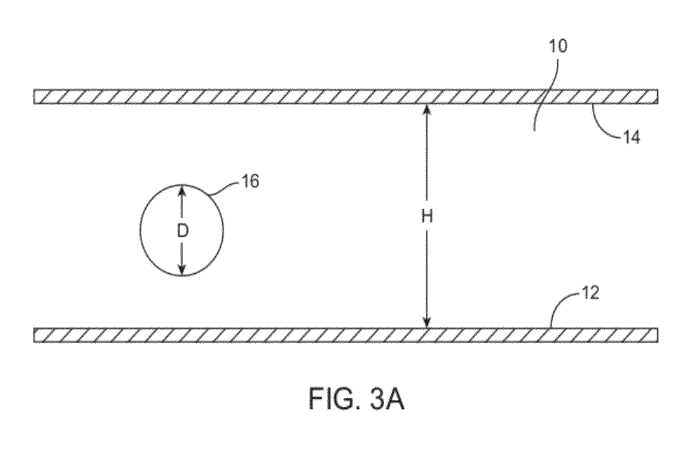

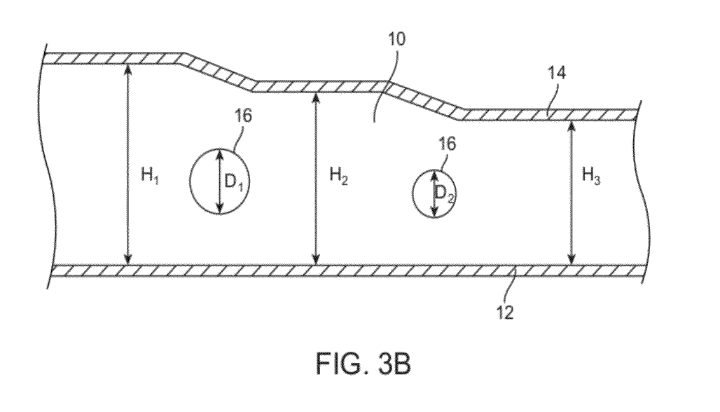

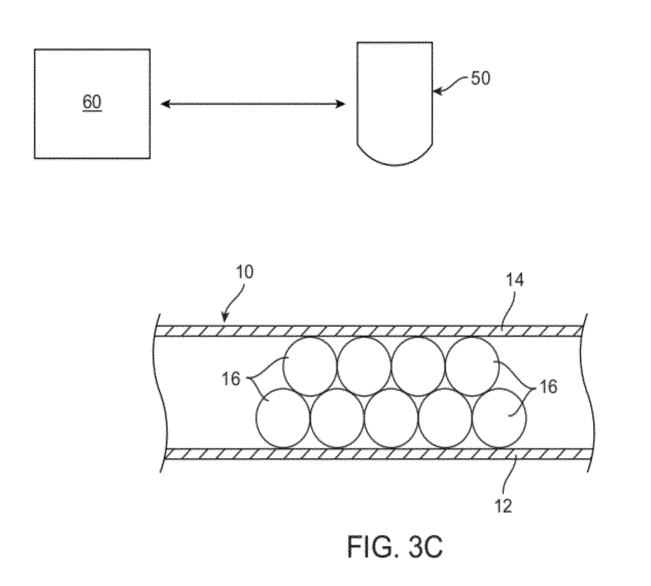

Droplets 16, as seen in FIGS. 3A and 3B, to be used for imaging and analysis for relevant analytical applications are generated. Droplets 16 may be referred to herein as micro-reactors. Droplets 16 may be generated in any number of ways commonly known to those skilled in the art including generation in a monodisperse fashion using microfluidic flow focusing droplet shearing of aqueous droplets using side shear flow of oil. The water to oil (w/o) volume ratio can be optimally tuned to achieve a close packing configuration of the droplets 16. Alternatively, the oil can be drained out and removed from the emulsion to achieve the w/o volume ratios required for high density droplet packing configurations. Similarly, oil may be added to loosen the droplet packing formations for looser packing if needed.

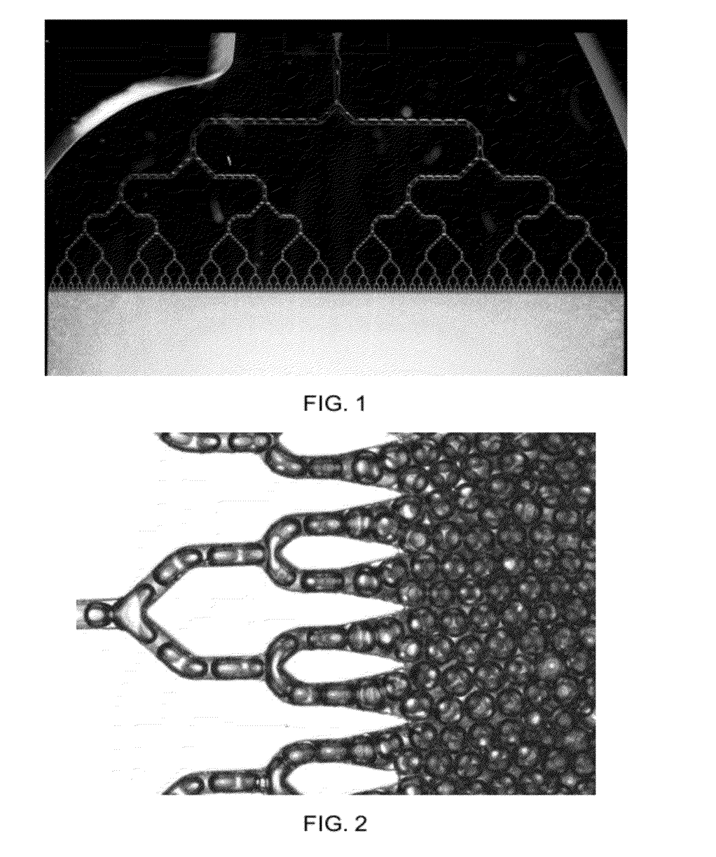

Generally, the w/o volume ratio in a given microfluidic volume of the device ranges from about 45% to 68%. The continuous or outer-phase component may include oils that are used to create a plurality of aqueous droplets 16. These include mineral oils, fluorocarbon-based oils, and the like. The aqueous phase of the droplets 16 may also contain additives to control, for example, the refractive index of the droplets or the interfacial tension of the emulsion. Surfactants and additives can be added to both the continuous oil phase and the discrete water phase to stabilize the droplet emulsion against coalescence or droplet fusion. Furthermore, additives may be included to reduce surface-surface interactions or trans-membrane transport of small molecules. FIG. 1 and FIG. 2 illustrate rapid generation and subsequent self-assembly of crystalline droplet pattern formations when generated at high w/o volume ratios using a 256 droplet splitter design. The droplets 16 are collected in a collection reservoir that includes a micro-well, chamber, or other collection region generally used in conjunction with microfluidic devices. FIGS. 3A and 3B illustrate exemplary collection reservoirs 10.

The droplets 16 have a diameter D which may be substantially constant or it may vary. The droplets 16 that are generated in the device may be modified to have varying diameters (D) in order to form the desired packing configuration.

FIG. 3C illustrates a cross-sectional view of droplets 16 contained within a collection reservoir 10. Also illustrated in FIG. 3C is an imaging device 50 that may include a microscope or the like. The imaging device 50 is generally oriented perpendicular to the collection reservoir 10 and the layers of droplets 16 contained therein. The imaging device 50 may image or capture image frames of the droplets 16 contained within the collection reservoir 10. The capture images or image frames may be two-dimensional or three-dimensional images. Further, the image or image frames may be transferred or otherwise stored in a computer 60 that is associated with or otherwise connected to the imaging device 50. The computer 60 may utilize image processing software such as ImageJ software to perform detection, characterization, digital quantification, and radial profile analysis of droplets 16.

It has been discovered that controlling the Height to Droplet Diameter Ratio (HDR) of the droplet collection region can produce a variety of predictive crystalline packing formations. Such formations include single, double, or triple layer face center cubic (FCC) like colloidal crystal patterns. These may embody Miller lattice orientations with (111), (100), and (110) lattice patterns. To illustrate, FIGS. 3A and 3B feature exemplary collection reservoirs 10. The collection reservoirs 10 have a lower surface 12 and an upper surface 14 with a chamber height (H) between the two. This height (H) may be adjusted or tailored by manufacturing the device to have a desired height. In FIG. 3A, the distance between the lower surface 12 and the upper surface 14 is substantially uniform. In FIG. 3B, the distance between the lower surface 12 and the upper surface 14 varies along portions of the collection reservoir 10 (e.g., H₁>H₂>H₃). For example, a single device may have different collection reservoirs 10 with different HDRs. Also illustrated in FIG. 3A is a droplet 16 having a diameter (D). FIG. 3B illustrates different droplets 16 having different diameters (D₁ and D₂). The HDR of the droplet 16 and the chamber height is the mathematical ratio of H:D. Table 1 reproduced below gives predictions for HDR values ranging from 1 to 1.82 using a simple sphere packing model, thus demonstrating percent changes in droplet packing density, image area coverage, and droplet area overlap. Dynamic HDR control is achieved by adjusting droplet diameter D for a given chamber height H, or changing the chamber height H for a given droplet diameter D.

TABLE 1

| | Drops per | % Increase | % Area | % Droplet |
|---|---|---|---|---|
| HDR | unit area | in Density | Coverage | Overlap |
| 1 | 1 | 0 | 90.7 | 0 |
| 1.45 | 1.17 | 17 | 97.4 | 16.5 |
| 1.7 | 1.73 | 73 | 100 | 72.6 |
| 1.82 | 2 | 100 | 97.6 | 92.4 |

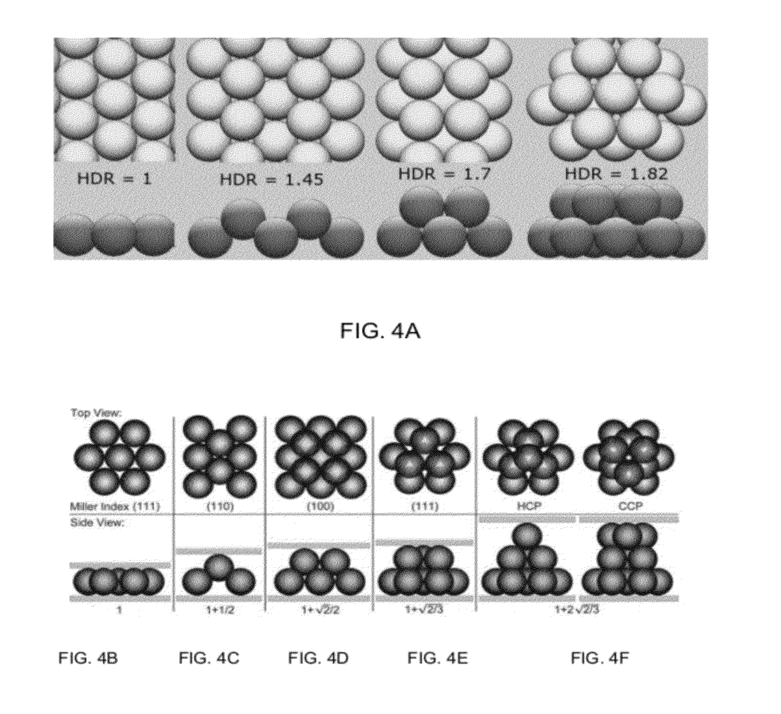

FIG. 4A illustrates the crystalline pattern formation predictions based on a spherical droplet model for different chamber height to droplet diameter ratios, such as those provided in Table 1. A HDR of 1.0 results in single layer hexagonal packing A HDR between 1 and 1.7 results in mixed height close packing designs with various levels of overlap. A HDR of 1.7 results in double layer close square packing, and an HDR of 1.82 results in double layer close hexagonal packing. As shown in the FIGS. above and in Table 1, adjusting HDR at different values creates patterns ranging from single layer arrays to multiple-layer arrays having varying degrees of overlap and droplet density, which may in turn range from 90% area coverage to 100% area coverage of the imaging plane. FIGS. 4B-4F illustrate other predicable close-packed colloidal crystal patterns expected for monodisperse droplet emulsions in five different HDR configurations.

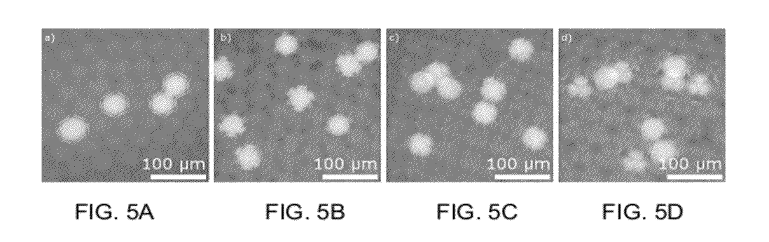

FIGS. 5A-5D are digital microfluidic images (fluorescent) with HDR values similar to those illustrated previously in FIG. 4A. In particular, the image of FIG. 5A features an HDR=1, with single layer hexagonal packing and zero overlap of droplets. The density is slightly higher than that of a simple sphere packing model, due to deformation of the droplets. The image of FIG. 5B has an HDR=˜1.45, with a loose square packing arrangement and a ˜17% increase in density. The image of FIG. 5C features an HDR=1.7, with close square packing of droplets resulting in a ˜73% droplet overlap and a ˜73% increase in packing density. The image of FIG. 5D features an HDR=1.82, with double layer hexagonal packing having a ˜93% overlap of droplets and a ˜100% increase in droplet density. Even with high percentages of droplet overlap in these multilayer configurations, individual droplets can still be detected using automated image processing algorithms and commercial software that are well-known in the art.

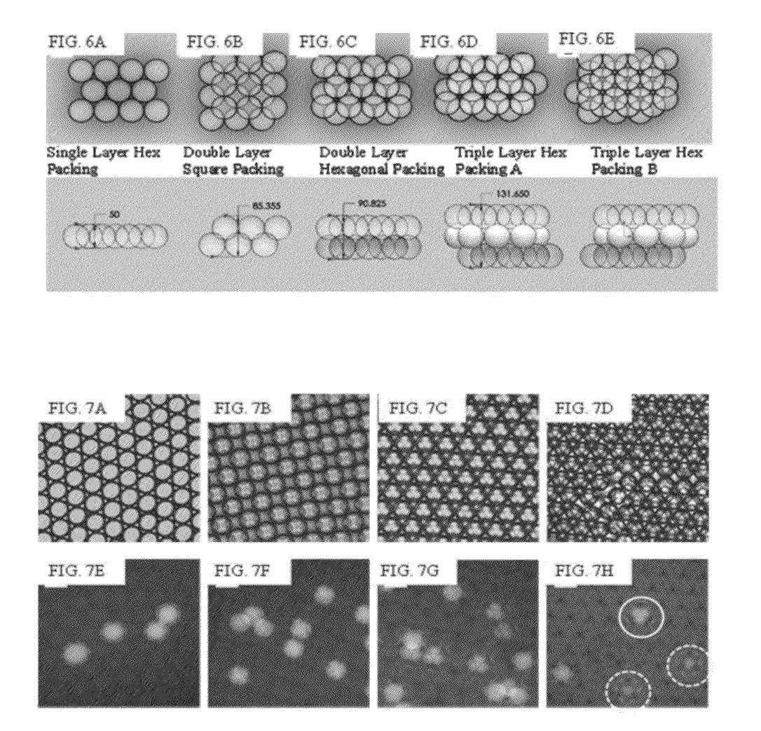

FIGS. 6A-6E illustrate various self-organizing packing configurations with FIGS. 6A-6D illustrating self-organizing droplet sphere packing configurations as a function of chamber height and droplet diameter, using an exemplary droplet diameter of 50 μm. A HDR of 1:1 or less will result in a tightly arranged hexagonal droplet packing configuration, as shown in FIG. 6A, where any given droplet is touching or “kissing” six other droplets and the top and bottom surface of the chamber. Increasing the HDR to (1+(√2)/2):1 will favor a body-centered cubic (bcc) alignment of droplets in a square packing double layer configuration, as shown in FIG. 6B, where any given droplet is kissing eight other droplets and the top or bottom surface of the chamber. Increasing the HDR to (1+√2/3)):1 will favor a face-centered cubic (fcc) alignment of two full droplet layers in a hexagonal packing configuration, as shown in FIG. 6C, where any given droplet is kissing nine other droplets and the top or bottom surface. Further increasing the HDR to (1+√4/3)):1 can yield two differing fcc configurations. One such configuration is the close-packed triple layer hexagonal packing shown in FIG. 6D, where the top layer is directly aligned and overlapping the bottom layer. Another configuration is the triple hexagonal packing configuration shown in FIG. 6E, where all three layers are uniquely aligned and some portion of each layer can still be seen from the top viewing plane, albeit with a very large overlapping percentage.

FIGS. 7A-7H illustrate a comparison of bright field images (see FIGS. 7A-7D) and fluorescence images (see FIGS. 7E-7H) of single layer to triple layer self-assembled droplet sphere packing configurations viewed on an Olympus inverted microscope. The FIG. 7A bright field and FIG. 7E fluorescence images feature single layer hexagonal droplet packing with a 46 μm collection reservoir height and a 48 μm droplet diameter. The FIG. 7B bright field and FIG. 7F fluorescent images feature double layer square packing of 46 μm diameter droplets in a collection reservoir with a height of 75 μm. Here, a large portion of the droplets on the second layer are still easily visible, even with other fluorescent droplets directly contacting these droplets. The FIG. 7C bright field and FIG. 7G fluorescence images feature double layer hexagonal packing of 46 μm diameter droplets in a collection reservoir with a height of 80 μm, which is slightly lower than the theoretical height of 83 μm due to the deformability of the droplets, as opposed to the droplets being rigid spheres. The FIG. 7D bright field and FIG. 7H fluorescent images feature triple layer hexagonal packing FIG. 7A configuration of 46 um diameter droplets in a chamber height of 115 μm. Again, the chamber height suited for triple hexagonal packing is slightly lower than the predicted 121 um height minimum due to the deformability of the droplets. Further noting FIG. 7H, the two fluorescent droplets outlined by the white dashes on the bottom layer are visible but difficult to detect, and each would be eclipsed by a fluorescent droplet positioned directly in front of them. Droplets in the second or middle layer outlined by the solid white line are easily visible and not completely aligned with any other droplets.

A primary advantage to be gained from the methods and devices described herein is that the density of reactor arrays (e.g., droplets) per unit area are increased two-fold or three-fold, utilizing predictable and complementarily aligned droplet pattern formations that are easily generated on demand due to their natural self-assembly. The pattern arrangement of the arrays also allows adequate image processing and resolution to distinguish the light intensity levels of all droplet reactors. In addition, this method reduces the manufacturing process demands required to incorporate high density reactor arrays on common substrates such as glass slides. The amount of droplet overlap and level of droplet density can be dynamically tuned by adjusting either the discrete phase to continuous phase volume ratios to favor tighter or looser droplet packing formations, or by adjusting the top and bottom plate spacing (e.g., spacing between lower surface 12 and an upper surface 14) to favor varying crystal lattice packing formations. Similarly, the droplet volumes can be selectively tuned on demand while they are generated by controlling the droplet formation shearing rates.

An additional advantage of the overlapping pattern formation is that the reactor density is increased without reducing the reactor volume or pixel coverage per unit reactor area. This allows for imaging of higher density reactor arrays without requiring high magnification imaging techniques to achieve the imaging, thus reducing demand on depth of focus limitations to visualize all droplets in a different imaging plane.

Additionally, by keeping the separation between reactor planes very small—for example, less than a single droplet radius in the case of crystalline droplet patterning formations—the depth of field required to adequately resolve all reactor planes at once does not become prohibitively burdensome on optical imaging setups. This reduces the complexity and overall cost of the imaging process.

This application is favorably suited for assays for which it is desired to individually visualize and observe a large number of reactors in very high density. This design performs particularly well in digital biological applications in which a number of droplets containing active reactive components is low compared to the total number of droplets present, such as with detecting small numbers of rare cells, DNA, RNA, organisms, bacteria, and others, from a large sample volume.

### Example

### Droplet-Based Digital PCR

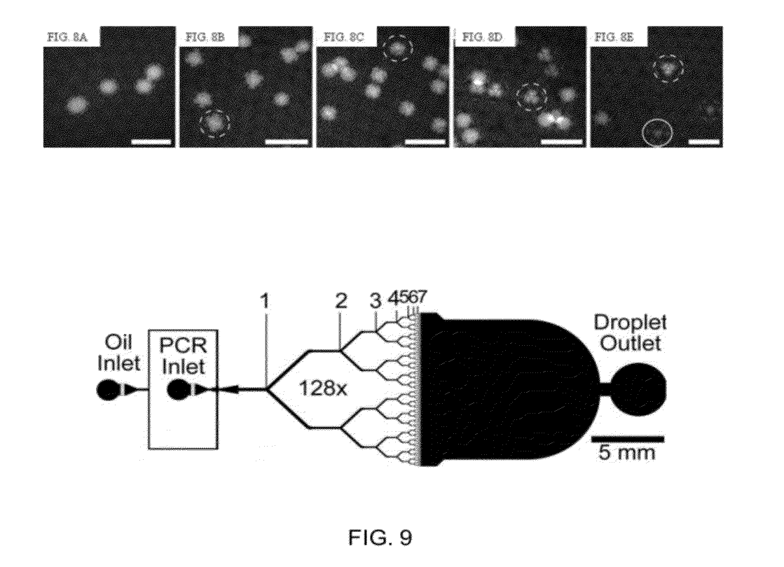

Droplet-based digital PCR was conducted using droplets (100,000 or more) that were captured in a downstream collection reservoir and imaged in 1 cm² areas. Experimental results were determined from fluorescence microscopy images like those shown in FIGS. 8A-8E. These end-point fluorescence images yield a direct correlation of a sample's starting DNA template concentration, and the number of positive fluorescing droplets. This is possible because Poisson probability distributions predict there is a low probability of encapsulating more than a single DNA copy per droplet when using low copy number DNA solutions. Few of the droplets coalesced during thermocycling. In addition to these experiments, completion of three independent droplet PCR experiments in double layer (111) packing configurations were performed to demonstrate the capability of multilayer digital PCR imaging and quantification for quantitative digital biology applications. The samples contained DNA concentrations of 3,000 copies per 20-μl reaction volume and discretized into 50 pL droplets yielding a Poisson distribution prediction of one positive droplet in 133±11.5 (s.d.) negative droplets. The experiments yielded on average one positive droplet in 131±5 (s.d.) negative droplets (N=100,000) per experiment. This close correspondence between experimental and predicted results demonstrates repeatable precision and performance of this high-density design to resolve and detect digital biology reactions in multilayer droplet images.

The close correlation between end-point fluorescence images and the number of positive fluorescing droplets with the sample's starting DNA template concentration indicates low loss of sample to surrounding oil media or microfluidic devices. In addition, accurate digital quantification is achieved because Poisson probability distributions predict a low probability of encapsulating more than a single DNA copy per droplet, less than 5% error, when assuming random DNA encapsulation frequencies of less than 5% of the total number of droplet reactors.

Selecting the appropriate oil phase and stabilizing surfactants for reaction compatibility and droplet stability is important for their function as an inert and stable volume-reactor. As most DNA-based reagents and enzymes have a highly polarized structure, they have a strong propensity to remain in the aqueous phase in the emulsion. However, some proteins and molecules may migrate to or through the oil/water interface depending on their size and amphiphilic properties. Alternative surfactant/oil combinations such as perfluorinated polyethers-polyethyleneglycol block-copolymer surfactant (PFPE-PEG) in fluorinated oils may be utilized to minimize this effect. Still, the compounds of primary interest in these experiments, target DNA strands and fluorophores, were not observed to readily transmit across, or get absorbed into, the droplet-droplet interfaces. This is evident in the experimental results by the large number of individual fluorescent droplets surrounded by non-fluorescing droplets as seen in FIGS. 8A-8E, and the high level of correspondence between predicted and experimental digital PCR results.

Microfluidic devices were fabricated from glass and Polydimethylsiloxane (PDMS) using standard soft lithography processes. Microfluidic master molds of SU-8 2050 (MicroChem) on 3″ prime silicon wafers were fabricated in a clean-room facility using the mask design illustrated in FIG. 9 and their thickness measured using a Dektak profilometer (Veeco). Each device consists of a single SU-8 height designed with oil and PCR inlets, a flow focusing droplet generator, 128 droplet splitter, droplet packing chamber and a single outlet. Sylgard-184 PDMS (Dow Corning) was molded on top of the SU-8 molds following standard curing protocol. The microfluidic devices were assembled by bonding 1 mm thick borosilicate 1″×3″ glass slides to both the top and bottom of the PDMS molds using air plasma treatment.

This experiment utilized an oil and surfactant combination that favored high w/o volume ratio emulsions, limited droplet fusion during heating and cooling processes, and reaction compatibility with the Taq-polymerase and other PCR reagents. PCR solutions were prepared using a standard protocol of Amplitaq Gold Fast PCR Master Mix, UP (2×) PCR kit (Applied Biosystems) and custom Taqman forward/reverse primer pairs, DNA strands, and fluorescent Taqman probes (Advanced Biotechnologies Inc.). Solutions were prepared as 20 μL reactions with the following final concentrations: forward/reverse primers (0.9 μM), probe (0.3 μM), 1×PCR master mix, and approximately 3,000 DNA copies. BSA (3-5 μg/μL) was added to the solution to reduce surface adsorption of DNA or enzymes to the PDMS substrate or tubing, and helped further stabilize the droplet emulsions. The oil phase was prepared from heavy mineral oil with 2-3% wt/wt EM90 and 0.05% wt/wt Triton-X 100 as stabilizing surfactants.

PCR and oil solutions were loaded into Tygon microbore tubing then injected into microfluidic devices using Pico-Plus syringe pumps (Harvard Apparatus). A flow focusing droplet generator formed the initial droplet emulsion, then seven subsequent bifurcation junctions further split the primary droplet into 128 smaller droplets. Droplet generation was performed at flow rates of 4 μL/min PCR solution and 2 μL/min oil resulting in droplet generation frequencies of 1.33 kHz and a 66% w/o volume ratio. Other w/o volume ratios were generated by adjusting the w/o flow rate relative to the oil flow rate, then adjusting the combined flow rates to a create a shear profile favoring droplet sizes with the desired 50 pL volume. After droplets finished forming and splitting, they entered a 1 cm×1.2 cm chamber area with vertical heights varying from 40 to 130 μm (i.e., collection reservoir). After the droplets filled the chamber, all inlets and outlets were clamped shut to prevent fluid flow in or out of the chamber.

Microfluidic devices were thermo-cycled on a Thermo Electric Cooler (TEC) controlled using a FTC-100 controller hardware and software (Ferrotec Inc). Temperature feedback to control the thermocycling apparatus was accomplished by inserting a copper plate with embedded thermocouple between the microfluidic and TEC device. A custom-fabricated liquid-cooled aluminum block was placed beneath the TEC device to dissipate waste heat. Two-step PCR thermocycling was initiated with a 10 minute “hot start” at 95° C. to activate the enzymes. Following this, forty temperature cycles, alternating between 58° C. and 95° C. with a twenty second hold at each of these temperatures, allowed amplification of the nucleic acid. Temperature ramp rates of 2-3° C./sec were used for both heating and cooling.

Fluorescence images were captured on an inverted fluorescence microscope (Olympus) with a monochrome cooled CCD camera (Hamamatsu) and images captured using Wasabi (1.4.2) capture software. ImageJ42 software was used to automatically detect and quantify fluorescent droplets and analyze their size, shape, color, fluorescence intensity, spacing, radial profile, droplet patterns, edge detection schemes, and watershed separation schemes. Background subtractions, contrast enhancement, and flatfield corrections were performed as needed during quantification of results. These results were then compared to the expected number of positive droplets predicted from Poisson statistics for serial dilutions of the known sample concentration.

Still referring to FIGS. 8A-8E, a composition of fluorescence images are presented demonstrating single layer to triple layer self-assembled droplet sphere packaging configurations. FIG. 8A illustrates single layer (111) hexagonal droplet stacking FIG. 8B illustrates double layer (110) packing FIG. 8C illustrates double layer (100) square packing FIG. 8D illustrates double layer (111) hexagonal packing FIG. 8E illustrates triple layer (111) HCP hexagonal packing. The dashed circles in FIGS. 8B-8E illustrate droplets in the second layer while the solid circle represents droplets in the third layer.

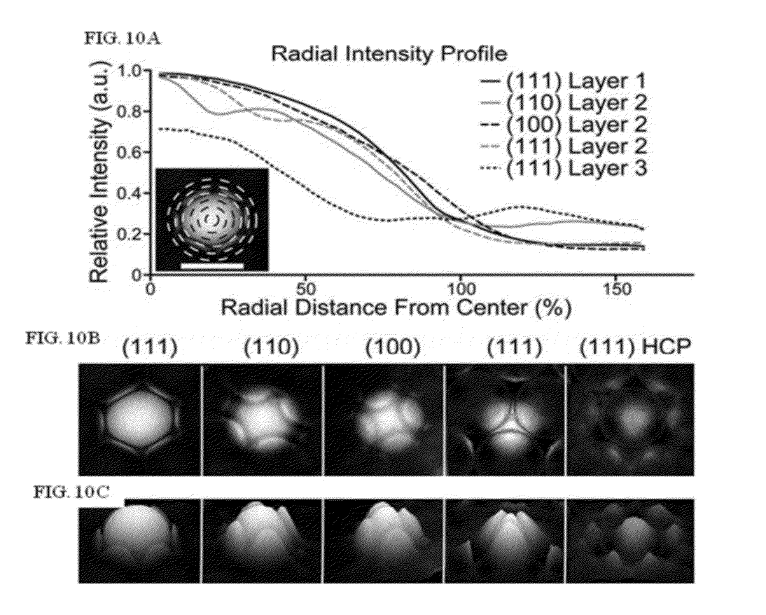

In addition to the PCR experiments performed for each packing configuration shown in FIGS. 8A-8E, completion of three independent droplet PCR experiments in double layer (111) packing configurations were performed to demonstrate the capability of multilayer, n>1, digital PCR imaging and analysis for quantitative digital biology applications. Fluorescence images were further analyzed to determine the relative variation in excitation and emission intensities for droplets in n=1, 2, or 3 planes. Droplet fluorescence levels vary as a function of n because of light absorption, reflection, and scattering at each successive droplet oil interface. FIG. 10A illustrates the radial profile plots of droplets in each layer of the varying droplet pattern formations. FIG. 10B illustrates surface intensity plots of droplets in each layer of the varying droplet pattern formations demonstrating the level of fluctuation exhibited in each droplet's fluorescence intensity. FIG. 10C illustrates the three-dimensional intensity surface plots of the same images of FIG. 10B for better profile visualization and demonstrate that for n=1 or 2 fluorescence excitation profiles, maximum intensity is relatively unchanged near the center of the droplet where there is no overlap but, a reduction occurs in the immediate vicinity of overlapping edges with other droplets. In the remaining regions of the overlapping droplet areas, fluorescence emission still transmits through with less than 5% attenuation. Droplets residing on the third layer in an n=3 HCP formation suffer from more severe interference from droplets in the uppermost layer resulting in as much as 40% attenuation in image intensity. This dramatic reduction indicates that the scattering of light, focal depth, and light transmission play crucial roles as n increases.

Upon inspection, it is apparent that the non-overlapping droplet areas in the imaged array also correspond to the thickest central droplet regions containing the majority of fluorescence signal information. More than 65% of the volume of a sphere is located within the central 50% of the droplet's imaged area. In the (100) square packing image shown in FIG. 10B, the total area coverage increases to 100% of the imaging plane with more than 35% of the total droplet volume residing in the non-overlapping central droplet regions. Two mechanisms are possible for determining each overlapping droplets average intensity, including (1) exclusive use of a droplets central region, or (2) utilizing the entire droplet area by interpolating each droplets contribution to the overlapping areas. This is achievable because as seen in FIGS. 8C & 8D, fluorescence intensities of two overlapping fluorescent droplets have brighter fluorescence levels in those regions, demonstrating an additive contribution to fluorescence intensity. As seen in FIG. 10A, the overlapping droplet regions can still transmit as much as 90% of their original intensity. The use of automated image processing algorithms to perform pattern recognition, image correction, and quickly analyze complex patterns, may further increase the high-throughput potential of this design by allowing lower magnification imaging for higher fields of view.

Assays with extremely high concentrations of positive droplets that express non-uniform fluorescence intensities, such as cell expression assays in super-Poisson encapsulation efficiencies and fluorescence analysis of higher order 3D arrays, may suffer from greater background levels and droplet-droplet cross-talk. As this would make fluorescence imaging and quantification more difficult, lower order patterning in (110) or (100) configurations would be more suitable and could be selected by controlling HDR to suit the assay. Although the increase in density is less dramatic, the gain in sensor area coverage would be useful. Assays with low concentrations of positive droplets that express uniform fluorescence levels, such as low concentration single-molecule detection, tolerate higher levels of overlap making two and even three layer configurations more suitable. Due to the low DNA copy number of the sample solutions tested in the three layer (111) HCP designs, the probability of having two positive droplets in overlapping top and bottom layer configurations is low, therefore no images demonstrating this were captured. One would expect that higher target concentrations would increase the probability of this happening. However, previous discussions suggest that even in this scenario, end-point quantification could still distinguish between the brighter fluorescence intensity of two overlapping positive droplets if all droplets express the same relative fluorescence intensity. To with, a three layer CCP droplet pattern would avoid direct overlapping of the first and third layer, making it highly favorable to perform future research to further investigate ways to preferentially achieve this pattern.

One primary benefit of using three-dimensional droplet patterning to increase droplet density is that it requires a smaller area to both visualize and fluorescently excite the same number of reactors. The smaller field of view allows for a higher imaging magnification if desired, and for the excitation light source to be used more efficiently to increase the overall fluorescence excitation intensity. This occurs because the marginally diminished light that would have normally transmitted through the first layer and gone unused now passes through to subsequent droplet layers yielding greater usage of fluorescence excitation illumination.

Furthermore, by allowing reactor areas to overlap, pixels on the imaging sensor are used more efficiently. This economy in pixel resolution is actually two fold. First, the area coverage of the imaging sensor is increased to 100% meaning all available pixels are used. Second, by allowing image projections of overlapping droplet reactors that are predictably patterned on the imaging sensor, a higher magnification can be achieved allowing a greater pixel/droplet resolution, or allowing a lower resolution imaging sensor with some pixels shared among droplets and some not.

Forming similar high density 3D arrays using traditional rigid substrate reactor arrays would require complicated fabrication techniques that so far have been incapable of achieving such close proximity reactor planes that are also easy to fill and handle. A larger spacing between reactor planes would make it difficult to resolve multiple layers of wells using typical microscope objective depths-of-field of 5-100 mm.

With the system described herein, droplet spacing from the mid-plane of the first layer to the midplane of the third layer is as low as 75 mm for a 46 mm droplet. This close spacing allows the majority of all three layers to be simultaneously resolved in a single snapshot. Alternatively, biasing focus toward the furthest layer to compensate for its more obscured path from the imaging sensor yields a more even representation of all three layers. Backside illumination for fluorescence excitation can also help compensate for the bottom layers' obscured path by increasing its fluorescence excitation relative to those above. Refractive index (RI) matching, both of the microfluidic substrate material as well as the fluid emulsion, can play considerable roles in the overall imaging performance of high density droplet emulsions. In particular, RI mismatch of the fluid phases forming the droplet emulsion would be expected to cause localized lensing and scattering effects which adversely influence light transmission and clarity. Because of this behavior, RI optimization of the microfluidic devices and fluid phases could yield improved performance of multilayer droplet packing arrays by improving signal to noise ratios. It would be expected that the imaging quality for these devices will vary depending on the overall droplet size (radius of curvature will affect lensing properties), pattern formation in the array, refractive index matching of the solutions, and the direction of illumination for fluorescence excitation. RI mismatches between the continuous and discrete phases can be modified using additives in the aqueous phase, e.g. glycerol, Ficoll, or sucrose, or selecting different oils like fluorocarbon, silicon, and hydrocarbon based oils. The publication, Hatch et al., Tunable 3D droplet self-assembly for ultra-high density digital micro-reactor arrays, Lab Chip, 2011, 11, 2509-2517 (2011) is incorporated by reference as if set forth fully herein.

While embodiments of the present invention have been shown and described, various modifications may be made without departing from the scope of the present invention. The invention, therefore, should not be limited, except to the following claims, and their equivalents.

What is claimed is:

1. A method of collecting micro-reactors comprising:
forming a plurality of micro-reactors in a microfluidic device, each of the micro-reactors having a diameter (D);
transporting the micro-reactors into a collection region having a lower surface and an upper surface, wherein the lower surface is separated from the upper surface by a height (H); wherein the ratio of H:D is between 1.0 and 2.65.

2. The method of claim 1, wherein the micro-reactors comprise droplets.

3. The method of claim 1, wherein the diameter is constant.

4. The method of claim 1, wherein the diameter is adjustable.

5. The method of claim 1, wherein the distance between the lower surface and the upper surface is adjustable.

6. The method of claim 1, wherein distance between the lower surface and the upper surface varies along the collection region.

7. The method of claim 1, further comprising obtaining a two-dimensional image of the collected micro-reactors.

8. The method of claim 1, further comprising obtaining a three-dimensional image of the collected micro-reactors.

9. The method of claim 1, wherein the micro-reactors comprise a fluorescent emitting compound.

10. The method of claim 1, wherein the micro-reactors comprise PCR reagents and the micro-reactors are subject to thermocycling.

11. A microfluidic device comprising:
one or more microfluidic channels configured to hold a plurality of micro-reactors each having a diameter (D), the one or more microfluidic channels terminating in a collection region having a lower surface and an upper surface, wherein the lower surface is separated from the upper surface by a height (H); wherein the ratio of H:D is between 1.0 and 2.65.

12. The device of claim 11, wherein the micro-reactors comprise droplets.

13. The device of claim 11, wherein the distance between the lower surface and the upper surface is adjustable.

14. The device of claim 11, wherein distance between the lower surface and the upper surface varies along the collection region.

15. The device of claim 11, further comprising an imaging device configured to take a two-dimensional image of the micro-reactors in the collection region.

16. The device of claim 15, further comprising at least one processor configured to determine a three-dimensional configuration of the micro-reactors in the collection region.

17. A micro-reactor assembly in a microfluidic device, comprising:
a plurality of micro-reactors each having a diameter (D) and assembled in a chamber having a lower surface and an upper surface separated by a height (H), wherein the ratio of H:D is between 1.0 and 2.65, and wherein the plurality of micro-reactors form a self-assembled imaging configuration.

18. The micro-reactor assembly of claim 17, wherein the imaging configuration has a single layer.

19. The micro-reactor assembly of claim 17, wherein the imaging configuration has multiple layers.

20. The micro-reactor assembly of claim 19, wherein the multiple layers form an overlapping pattern for imaging of each layer without eclipsing each layer.
